(19) United States
(12) Patent Application Publication
(10) Pub. No.: US 2025/0167528 A1
(43) Pub. Date: May 22, 2025

(54) Aluminum Foil Stripping Device and Method

(71) Applicants: Tyco Electronics (Dongguan) Ltd., Dongguan City (CN); TE Connectivity Solutions GmbH, Schaffhausen (CH); Tyco Electronics (Shanghai) Co., Ltd., Shanghai (CN)

(72) Inventors: Lei (Alex) Zhou, Shanghai (CN); Zhenhua Liu, Dongguan (CN); Dandan (Emily) Zhang, Shanghai (CN); Roberto Francisco-Yi Lu, Bellevue, WA (US); Hongzhou (Andy) Shen, Dongguan (CN)

(73) Assignees: Tyco Electronics (Dongguan) Ltd., Dongguan City (CN); TE Connectivity Solutions GmbH, Schaffhausen (CH); Tyco Electronics (Shanghai) Co., Ltd., Shanghai (CN)

(21) Appl. No.: 18/955,157

(22) Filed: Nov. 21, 2024

(30) Foreign Application Priority Data
Nov. 22, 2023 (CN) 202311569727.7

(51) Int. Cl. H02G 1/00; B23K 26/38

(52) U.S. Cl. CPC H02G 1/00; B23K 26/38

(57) ABSTRACT

An aluminum foil stripping device for stripping aluminum foil exposed from one end of a cable includes a fixture, a single laser machine, a pair of cutters, and a grasping mechanism. The fixture is adapted to clamp and fix the cable. The single laser machine is adapted to cut a pre-cut on the exposed aluminum foil of the fixed cable to release the tension of the aluminum foil. The pair of cutters are adapted to simultaneously cut the aluminum foil each of two sides of the exposed aluminum foil, wherein a cutting position of the pair of cutters is aligned with the pre-cut. The grasping mechanism is adapted to grasp the exposed aluminum foil and separate it from the cable at the cutting position by at least one of oscillating or pulling the aluminum foil to remove it from the cable.

### CROSS-REFERENCE TO RELATED APPLICATION

This application claims the benefit of Chinese Patent Application No. CN202311569727.7 filed on Nov. 22, 2023 in the State Intellectual Property Office of China, the whole disclosure of which is incorporated herein by reference.

### FIELD OF THE DISCLOSURE

The present disclosure relates to an aluminum foil stripping device and an aluminum foil stripping method.

### BACKGROUND OF THE INVENTION

In the prior art, in order to establish an electrical connection, one end of a cable needs to be treated. Usually, it is necessary to first peel off an outer insulation layer of one end of the cable to expose a section of an aluminum foil layer. The exposed aluminum foil later is then peeled off to expose the cable conductor. When peeling off the aluminum foil layer, it is necessary to first cut slits on both radial sides of the aluminum foil layer. In the prior art, it is usually necessary to install a laser machine on both radial sides of the aluminum foil layer. Two laser machines simultaneously cut the aluminum foil from both radial sides of the aluminum foil layer to make the slits on both radial sides of the aluminum foil layer. Laser machines are expensive, and the cost of using two laser machines is too high. If only one laser machine is used, it is necessary to flip the cable to cut the slits on both radial sides of the aluminum foil layer in sequence, which will reduce the stripping efficiency of the aluminum foil layer.

### SUMMARY OF THE INVENTION

According to an embodiment of the present disclosure, an aluminum foil stripping device for stripping aluminum foil exposed from one end of a cable includes a fixture, a single laser machine, a pair of cutters, and a grasping mechanism. The fixture is adapted to clamp and fix the cable. The single laser machine is adapted to cut a pre-cut on the exposed aluminum foil of the fixed cable to release the tension of the aluminum foil. The pair of cutters are adapted to simultaneously cut the aluminum foil each of two sides of the exposed aluminum foil, wherein a cutting position of the pair of cutters is aligned with the pre-cut. The grasping mechanism is adapted to grasp the exposed aluminum foil and separate it from the cable at the cutting position by at least one of oscillating or pulling the aluminum foil to remove it from the cable.

### BRIEF DESCRIPTION OF DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative view of an aluminum foil stripping device according to an exemplary embodiment of the present invention, in which the cable is clamped and fixed by a fixture;

FIG. 2 shows an illustrative view of an aluminum foil stripping device according to an exemplary embodiment of the present invention, in which a laser machine cuts the exposed aluminum foil of a cable;

FIG. 3 shows an illustrative view of an aluminum foil stripping device according to an exemplary embodiment of the present invention, in which a laser machine cuts a pre-cut on the exposed aluminum foil of the cable;

FIG. 4 shows an illustrative view of an aluminum foil stripping device according to an exemplary embodiment of the present invention, in which a pair of cutters simultaneously cut the aluminum foil from both sides;

FIG. 5 shows an illustrative view of an aluminum foil stripping device according to an exemplary embodiment of the present invention, in which the grasping mechanism grasps the exposed aluminum foil of the cable; and

FIG. 6 shows an illustrative view of an aluminum foil stripping device according to an exemplary embodiment of the present invention, in which the exposed aluminum foil of the cable is removed by a gripping mechanism.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to one embodiment of the present disclosure, an aluminum foil stripping device for stripping aluminum foil exposed from one end of a cable is provided. The aluminum foil stripping device comprises a fixture for clamping and fixing the cable, a single laser machine which is used to cut a pre-cut on the exposed aluminum foil of the fixed cable to release the tension of the aluminum foil in advance, and a pair of cutters which are used to simultaneously cut the aluminum foil from both sides of the exposed aluminum foil. The cutting position of the pair of cutters is aligned with the pre-cut. A grasping mechanism of the device is used to grasp the exposed aluminum foil and separate it from the cable at the cutting position by shaking (or oscillating or vibrating) and pulling the aluminum foil and peeling it off of the cable.

According to another embodiment, a method for stripping aluminum foil is provided. The method includes the steps of: providing the aluminum foil stripping device; using the fixture to clamp and fix a cable; using the laser machine to cut a pre-cut on the exposed aluminum foil of the cable to release the tension of the aluminum foil in advance; moving the pair of cutters to align with the pre-cut and using the pair of cutters to simultaneously cut the aluminum foil from both sides of the exposed aluminum foil; and using the grasping mechanism to grasp the exposed aluminum foil and shake (or oscillate or vibrate) and pull it, so that the aluminum foil is separated from the cable at the cutting position of the pair of cutters and is peeled off from the cable.

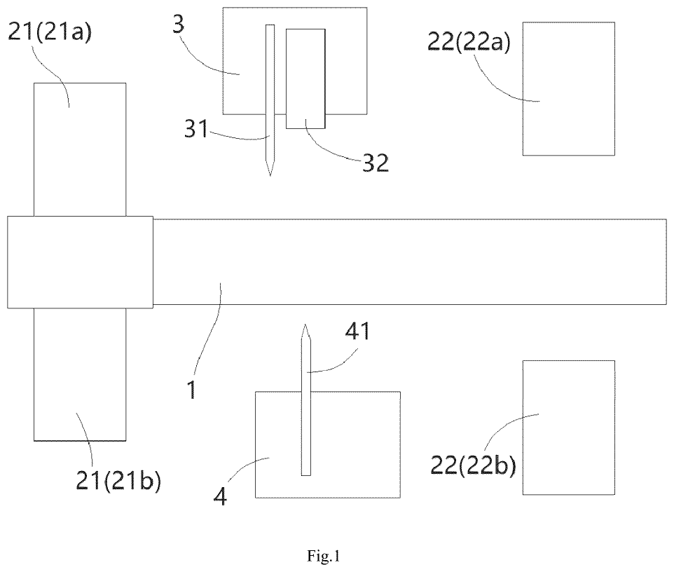

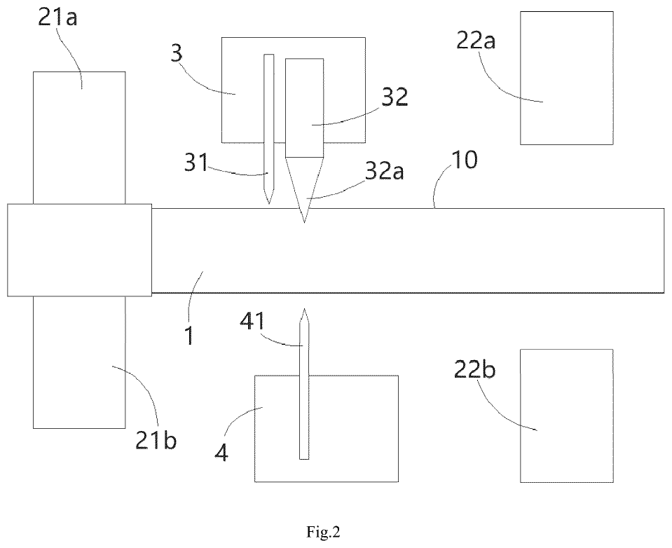

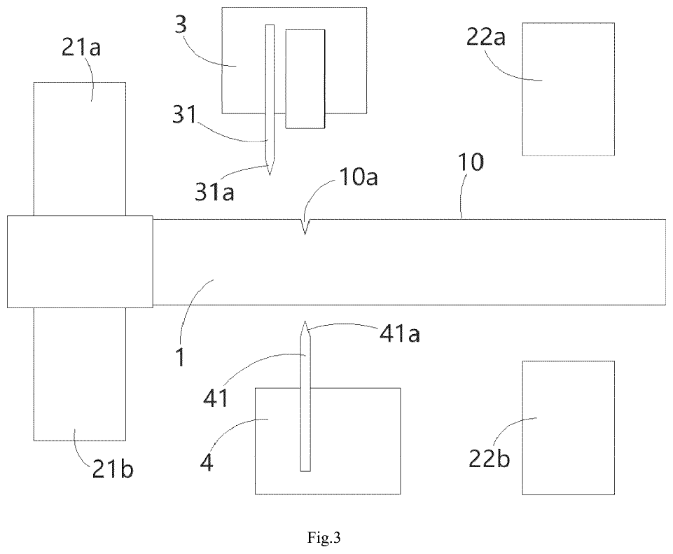

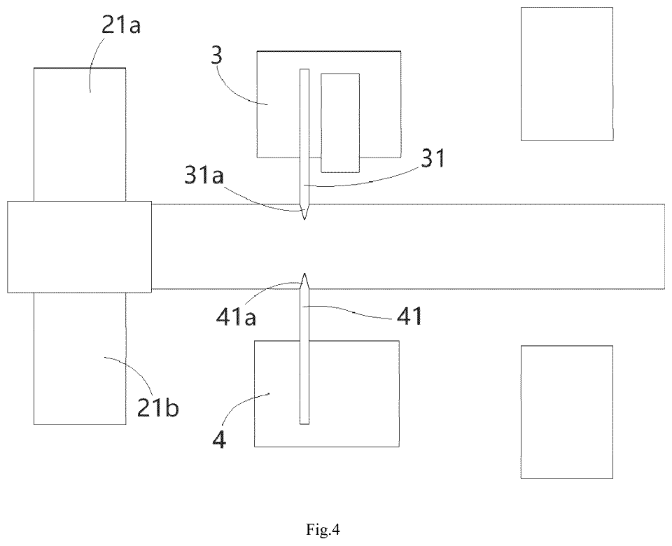

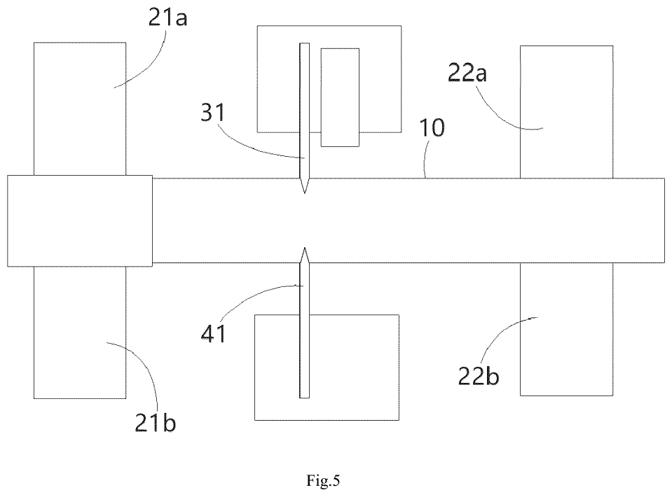

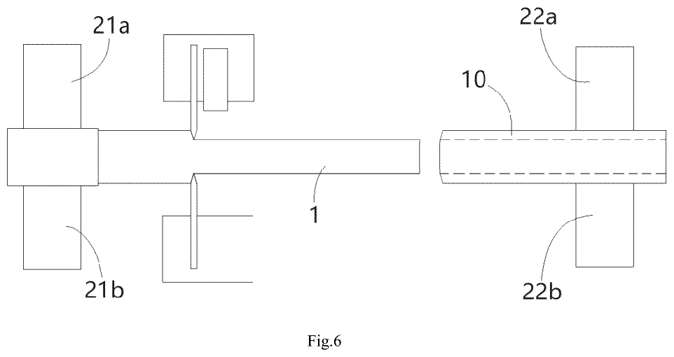

FIG. 1 shows an illustrative view of an aluminum foil stripping device according to an exemplary embodiment of the present invention, in which cable 1 is clamped and fixed by fixture 21. FIG. 2 shows an illustrative view of an aluminum foil stripping device according to an exemplary embodiment of the present invention, in which the laser machine 32 cuts the exposed aluminum foil 10 of the cable 1. FIG. 3 shows an illustrative view of an aluminum foil stripping device according to an exemplary embodiment of the present invention, in which a laser machine 32 cuts a pre-cut 10a on the exposed aluminum foil 10 of the cable 1. FIG. 4 shows an illustrative view of an aluminum foil stripping device according to an exemplary embodiment of the present invention, in which a pair of cutters 31, 41 simultaneously cut aluminum foil 10 from both sides of aluminum foil 10. FIG. 5 shows an illustrative view of an aluminum foil stripping device according to an exemplary embodiment of the present invention, in which the grasping mechanism 22 grasps the exposed aluminum foil 10 of the cable 1. FIG. 6 shows an illustrative view of an aluminum foil stripping device according to an exemplary embodiment of the present invention, in which the exposed aluminum foil 10 of cable 1 is removed by the grasping mechanism 22.

Referring generally to FIGS. 1-6, in an exemplary embodiment of the present disclosure, an aluminum foil stripping device is disclosed. This aluminum foil stripping device is used to strip the aluminum foil 10 exposed from one end of cable 1. In the illustrated embodiment, the stripping device mainly includes a fixture 21, a single laser machine 32, a pair of cutters 31, 41, and a grasping mechanism 22. The fixture 21 is used to clamp and secure the cable 1. The single laser machine 32 is used to cut a pre-cut 10a on the exposed aluminum foil 10 of the fixed cable 1, in order to release the tension of the aluminum foil 10 in advance. The pair of cutters 31 and 41 are used to simultaneously cut the aluminum foil 10 from both sides of the exposed aluminum foil 10, and the cutting positions of the pair of cutters 31 and 41 are aligned with the pre-cut 10a. The grasping mechanism 22 is used to grasp the exposed aluminum foil 10 and, by shaking and pulling the aluminum foil 10, separate it from the cable 1 at the cutting position and peel it off from the cable 1.

A pair of cutters 31, 41 include a first cutter 31 and a second cutter 41. The first cutter 31 is set at the first side of the exposed aluminum foil 10 for cutting the aluminum foil 10 from the first side. The second cutter 41 is set on at second side of the exposed aluminum foil 10, opposite to the first side, for cutting the aluminum foil 10 from the second side. The single laser machine 32 is located at the first side of the exposed aluminum foil 10, used to cut a pre-cut 10a on the first side of the aluminum foil 10.

In the illustrated embodiment, the aluminum foil stripping device further comprises a first movable plate 3 and a first driver (not shown). The single laser machine 32 and the first cutter 31 are installed on the first movable plate 3. The first driver is used to drive the first movable plate 3 and the single laser machine 32 and the first cutter 31 installed on it to move synchronously. However, the present invention is not limited to the illustrated embodiment. For example, the single laser machine 32 and the first cutter 31 can be installed on two different movable plates, so that the single laser machine 32 and the first cutter 31 can be moved separately.

The aluminum foil stripping device further comprises a second movable plate 4 and a second driver (not shown). The second cutter 41 is installed on the second movable plate 4. The second driver is used to drive the second movable plate 4 and the second cutter 41 installed on it to move synchronously.

The aluminum foil stripping device further comprises a movable block (not shown) and a driver (not shown). The fixture 21 is installed on the movable block. The driver is used to drive the movable block and the fixture 21 installed on it to move synchronously.

The grasping mechanism 22 includes a gripper (not shown) and a moving mechanism (not shown). The gripper includes multiple clamping claws 22a, 22b for gripping the aluminum foil 10. The moving mechanism is connected to the gripper and used to drive the gripper to move to shake and pull the aluminum foil 10 being grabbed.

The gripper includes an upper clamping claw 22a and a lower clamping claw 22a. The upper clamping claw 22a and the lower clamping claw 22b are located at the upper and lower sides of the exposed aluminum foil 10, respectively, and are used to clamp the aluminum foil 10 from the upper and lower sides of the aluminum foil 10.

The moving mechanism can be a robot, a robotic arm, or a three-coordinate moving platform.

The single laser machine 32 is located on the upper side of the exposed aluminum foil 10, used to cut a pre-cut 10a on the upper side of the exposed aluminum foil 10. The pair of cutters 31 and 41 are respectively located at the upper and lower sides of the exposed aluminum foil 10, used to simultaneously cut the aluminum foil 10 from both sides.

In another exemplary embodiment of the present invention, a method for stripping aluminum foil is also disclosed. The method includes the following steps:
S10: Providing the aforementioned aluminum foil stripping device;
S20: Using the fixture 21 to clamp and fix the cable 1;
S30: Using the laser machine 32 to cut a pre-cut 10a on the exposed aluminum foil 10 of cable 1, in order to release the tension of the aluminum foil 10 in advance;
S40: Moving the pair of cutters 31 and 41 to align with the pre-cut 10a and use them to simultaneously cut the aluminum foil 10 from both sides of the exposed aluminum foil 10; and
S50: Using the grasping mechanism 22 to grab the exposed aluminum foil 10 and shake and pull it, so that the aluminum foil 10 is separated from the cable 1 at the cutting position of the pair of cutters 31 and 41 and is peeled off from the cable 1.

The aforementioned step S20 further includes: after the cable 1 is clamped by the fixture 21, the fixture 21 is moved along the axial direction of the cable 1 to move the exposed aluminum foil 10 of the cable 1 to a predetermined processing position.

As shown in FIGS. 1 to 6, in the illustrated embodiment, the aforementioned step S30 includes:
S31: Moving the laser machine 32 to the predetermined cutting position;
S32: Starting the laser machine 32 to emit a laser beam 32 towards the aluminum foil 10; and
S33: Moving the laser machine 32 in the first direction perpendicular to the axis of cable 1 to cut a predetermined length of pre-cut 10a on the aluminum foil 10 through the laser beam 12a.

The aforementioned pre-cut 10a is spaced a predetermined distance in the axial direction of the cable 1 from the end face of the exposed aluminum foil 10.

In step S40, the pair of cutters 31, 41 are moved synchronously along a second direction perpendicular to the first direction and the axial direction of cable 1 to simultaneously cut aluminum foil 10 from both sides of the exposed aluminum foil 10.

The cutting depth of the pair of cutters 31, 41 is equal to or slightly less than the thickness of the aluminum foil 10 to prevent the pair of cutters 31, 41 from cutting other cable layers located inside the aluminum foil 10, for example, to prevent cutting the conductor inside the cable 1.

The aforementioned step S50 includes:
S51: Using the multiple clamping claws 22a, 22b of the gripper to clamp and grasp the exposed aluminum foil 10;
S52: Shaking the grasped aluminum foil 10 in a direction perpendicular to the axis of cable 1, so that the aluminum foil 10 is separated from the cable 1 at the cutting position; and
S53: Pulling the aluminum foil 10 away from the cutting position along the axial direction of the cable 1, so that the exposed aluminum foil 10 is peeled off from the cable 1.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. An aluminum foil stripping device for stripping aluminum foil exposed from one end of a cable, comprising:
a fixture for clamping and fixing the cable;
a single laser machine adapted to cut a pre-cut on the exposed aluminum foil of the fixed cable to release the tension of the aluminum foil;
a pair of cutters adapted to simultaneously cut the aluminum foil on each of two sides of the exposed aluminum foil, a cutting position of the pair of cutters is aligned with the pre-cut; and
a grasping mechanism adapted to grasp the exposed aluminum foil and separate it from the cable at the cutting position by at least one of oscillating or pulling the aluminum foil to remove it from the cable.

2. The aluminum foil stripping device according to claim 1, wherein the pair of cutters comprises:
a first cutter arranged on a first side of the exposed aluminum foil and adapted to cut the aluminum foil from the first side; and
a second cutter arranged on a second side of the exposed aluminum foil opposite to the first side, and adapted to cut the aluminum foil from the second side.

3. The aluminum foil stripping device according to claim 2, wherein the single laser machine is located at the first side of the exposed aluminum foil and is adapted to cut the pre-cut on the first side of the aluminum foil.

4. The aluminum foil stripping device according to claim 3, further comprising:
a first movable plate on which the single laser machine and the first cutter are installed; and
a first driver adapted to drive the first movable plate and the single laser machine and the first cutter installed on it to move synchronously.

5. The aluminum foil stripping device according to claim 4, further comprising:
a second movable plate on which the second cutter is installed; and
a second driver which is used to drive the second movable plate and the second cutter installed on it to move synchronously.

6. The aluminum foil stripping device according to claim 1, further comprising:
a movable block on which the fixture is installed; and
a driver adapted to drive the movable block and the fixture installed on it to move synchronously.

7. The aluminum foil stripping device according to claim 1, wherein the grasping mechanism includes:
a gripper having multiple clamping claws adapted to clamp the aluminum foil; and
a moving mechanism connected to the gripper and adapted to drive the gripper to move to oscillate and pull the grasped aluminum foil.

8. The aluminum foil stripping device according to claim 7, wherein the gripper includes an upper clamping claw arranged at a first side of the exposed aluminum foil, and a lower clamping claw arranged at a second side of the exposed aluminum foil.

9. The aluminum foil stripping device according to claim 7, wherein the moving mechanism is a robot, a robotic arm, or a three-coordinate mobile platform.

10. The aluminum foil stripping device according to claim 1, wherein the single laser machine is arranged at an upper side of the exposed aluminum foil and is adapted to cut the pre-cut on the upper side of the exposed aluminum foil.

11. The aluminum foil stripping device according to claim 10, wherein the pair of cutters are respectively located at the upper side and a lower side of the exposed aluminum foil, and are adapted to simultaneously cut the aluminum foil from each side.

12. The aluminum foil stripping device according to claim 1, wherein the grasping mechanism is adapted to oscillate and pull the aluminum foil to remove it from the cable.

13. A method for stripping aluminum foil, comprising the steps of:
S10: providing the aluminum foil stripping device according to claim 1;
S20: using the fixture to clamp and fix a cable;
S30: using the laser machine to cut a pre-cut on the exposed aluminum foil of the cable to release the tension of the aluminum foil;
S40: moving the pair of cutters to align with the pre-cut and using the pair of cutters to simultaneously cut the aluminum foil from both sides of the exposed aluminum foil; and
S50: grasping the exposed aluminum foil with the grasping mechanism to shake and pull the exposed aluminum foil, separating the exposed aluminum foil from the cable at a cutting position of the pair of cutters.

14. The method according to claim 10, wherein the step S20 further includes, after the cable is clamped by the fixture, moving the fixture along the axial direction of the cable to move the exposed aluminum foil of the cable to a predetermined processing position.

15. The method according to claim 13, wherein the step S30 includes:
S31: moving the laser machine to a predetermined cutting position;
S32: emitting a laser beam towards the aluminum foil with the laser machine; and
S33: moving the laser machine in a first direction perpendicular to an axial direction of the cable to cut a predetermined length of pre-cut on the aluminum foil with the laser beam.

16. The method according to claim 15, wherein the pre-cut is spaced a predetermined distance in the axial direction of the cable from an end face of the exposed aluminum foil.

17. The method according to claim 16, wherein in the step S40, the pair of cutters are moved synchronously along a second direction perpendicular to the first direction and the axial direction of the cable to simultaneously cut the aluminum foil from both sides of the exposed aluminum foil.

18. The method according to claim 13, wherein a cutting depth of the pair of cutters is equal to or slightly less than the thickness of the aluminum foil to prevent the pair of cutters from cutting other cable layers located inside the aluminum foil.

19. The method according to claim 13, wherein the step S50 further includes:
S51: using multiple clamping claws of the gripper to clamp and grasp the exposed aluminum foil; and
S52: shaking the grasped aluminum foil in a direction perpendicular to the axial direction of the cable, so that the aluminum foil is separated from the cable at the cutting position.

20. The method according to claim 19, wherein the step S50 further includes:
S53: pulling the aluminum foil along the axial direction of the cable in a direction away from the cutting position, so that the exposed aluminum foil is peeled off from the cable.
